(19) United States
(12) Patent Application Publication
(10) Pub. No.: US 2023/0058243 A1
(43) Pub. Date: Feb. 23, 2023

(54) VEHICLE-MOUNTED POWER SUPPLY SYSTEM AND CORRESPONDING METHOD

(71) Applicant: Bel-O Transports Inc., Mont-Saint-Grégoire (CA)

(72) Inventors: Patrick Boucher, Mont St-Grégoire (CA); Danny Fournel Vézina, Saint-Paul-de-IÎle-aux-Noix (CA); Jean-François Mathurin, St-Jean-sur-Richelieu (CA)

(73) Assignee: Bel-O Transports Inc., Mont-Saint-Grégoire (CA)

(21) Appl. No.: 17/891,394

(22) Filed: Aug. 19, 2022

Related U.S. Application Data
(60) Provisional application No. 63/260,449, filed on Aug. 20, 2021.

(51) Int. Cl. B60R 16/033; H01M 10/42; H01M 10/44; H01M 10/615; H01M 10/6562

(52) U.S. Cl. CPC B60R 16/033; H01M 10/425; H01M 10/44; H01M 10/615; H01M 10/6562; H02K 11/0094

(57) ABSTRACT

The present disclosure concerns a vehicle-mounted power supply system, comprising: a vehicle-mounted battery assembly; an electric motor electrically coupled to the vehicle-mounted battery assembly; and a controller operatively coupled to the vehicle-mounted battery assembly and the electric motor to selectively provide a voltage outputted by the vehicle-mounted battery assembly to the electric motor. It also concerns a method for discharging a fluid from a tank of a truck with a truck-mounted fluid transfer pump system.

### PRIOR APPLICATION

The present application claims priority from U.S. provisional patent application No. 63/260,449, filed on Aug. 20, 2021, and entitled “VEHICLE-MOUNTED POWER SUPPLY SYSTEM AND CORRESPONDING METHOD”, the disclosure of which being hereby incorporated by reference in its entirety.

### TECHNICAL FIELD

The technical field relates to a vehicle-mounted power supply system, and more particularly to a truck-mounted power supply system to power an electric equipment of a truck, such as a fluid transfer pump.

### BACKGROUND

In the transport sector, it is often required to provide an external electrical power source to an electric device, for instance to charge or discharge a vehicle such as a truck with goods or fluids. In some situations, an external power source can hardly be found.

In view of the above, there is a need for a vehicle-mounted power supply system, which would be able to overcome or at least minimize some of the above-discussed prior art concerns.

### SUMMARY

It is therefore an aim of the present invention to address the above-mentioned issues.

According to a general aspect, there is provided a vehicle-mounted power supply system, comprising: a vehicle-mounted battery assembly; an electric motor electrically coupled to the vehicle-mounted battery assembly; and a controller operatively coupled to the vehicle-mounted battery assembly and the electric motor to selectively provide a voltage outputted by the vehicle-mounted battery assembly to the electric motor.

According to another general aspect, there is provided a truck-mounted fluid transfer pump system, comprising: a truck-mounted battery assembly; a fluid transfer pump assembly electrically coupled to the truck-mounted battery assembly; and a controller operatively coupled to the truck-mounted battery assembly and the fluid transfer pump assembly to selectively provide a voltage outputted by the truck-mounted battery assembly to the fluid transfer pump assembly.

According to another general aspect, there is provided a method for discharging a fluid from a tank of a truck, comprising: providing a truck-mounted fluid transfer pump system comprising a truck-mounted battery assembly electronically coupled to a fluid transfer pump; actuating the truck-mounted battery assembly to provide a voltage outputted by the truck-mounted battery assembly to the fluid transfer pump; and discharging the fluid from the tank.

### BRIEF DESCRIPTION OF THE DRAWINGS

FIG. 1 is a side-elevation view of a tank of a truck, comprising a vehicle-mounted power supply system in accordance with an embodiment;

FIG. 2 is an enlarged view of the vehicle-mounted power supply system of FIG. 1, comprising a vehicle-mounted battery assembly;

FIG. 3 is a rear elevation view of the truck of FIG. 1, the vehicle-mounted power supply system comprising an electric motor and a fluid transfer pump mechanically coupled thereto via a mechanical connector;

FIG. 4 is a top perspective view of the vehicle-mounted battery assembly according to another embodiment;

FIG. 5 is a top elevation view of the vehicle-mounted battery assembly of FIG. 4;

FIG. 6 is a side elevation view of the vehicle-mounted battery assembly of FIG. 4;

FIG. 7 is a top perspective view of the electric motor and the fluid transfer pump according to another embodiment mechanically coupled together by a mechanical connector;

FIG. 8 is a side elevation view of a mechanical connector according to another embodiment;

FIG. 9 is an upstream elevation view of a mechanical connector engaged with a fluid transfer pump according to another embodiment; and

FIG. 10 is a side elevation view of a mechanical connector engaged with an electric motor according to another embodiment.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Moreover, it will be appreciated that positional descriptions such as “above”, “below”, “forward”, “rearward”, “left”, “right” and the like should, unless otherwise indicated, be taken in the context of the figures only and should not be considered limiting. Moreover, the figures are meant to be illustrative of certain characteristics of the vehicle and of the power supply system mounted thereto and are not necessarily to scale.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the following description, an embodiment is an example or implementation. The various appearances of “one embodiment”, “an embodiment” or “some embodiments” do not necessarily all refer to the same embodiments. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. It will be appreciated that the methods described herein may be performed in the described order, or in any suitable order.

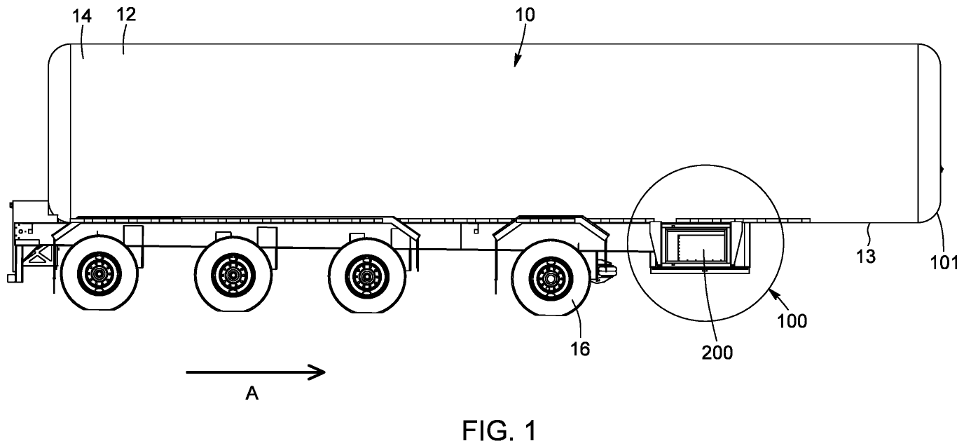

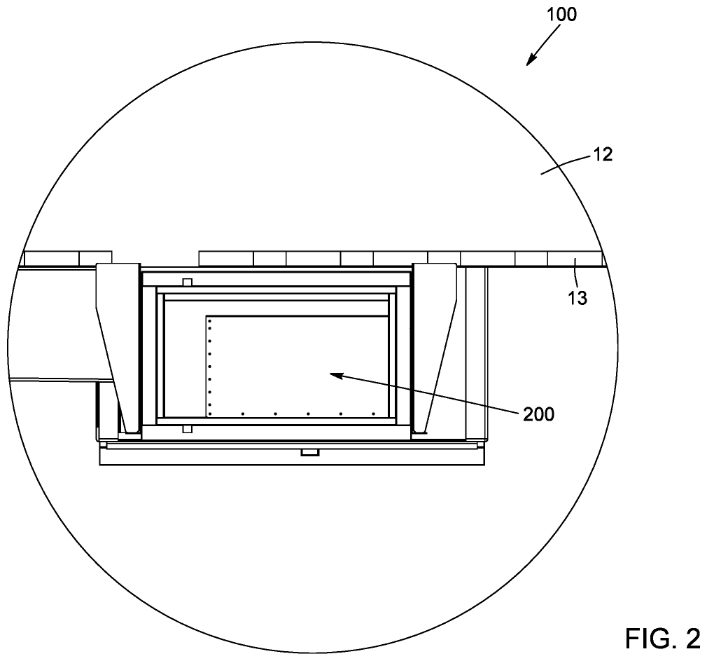

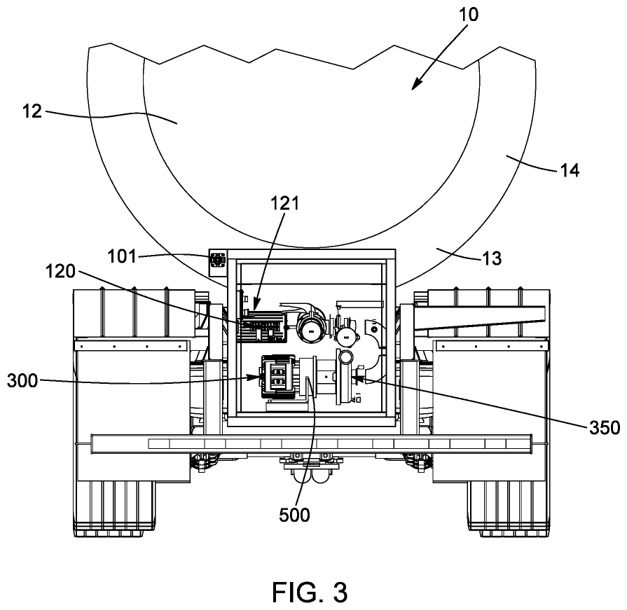

Referring now to the drawings, and more particularly to FIGS. 1 to 3, there is shown a vehicle-mounted power supply system 100. In the embodiment shown, the vehicle-mounted power supply system 100 comprises a vehicle-mounted battery assembly 200, an electric motor 300 electrically coupled to the vehicle-mounted battery assembly 200 and a controller 120 operatively coupled to the vehicle-mounted battery assembly 200 and the electric motor 300 to selectively provide a voltage outputted by the vehicle-mounted battery assembly 200 to the electric motor 300.

In the embodiment shown, the vehicle-mounted power supply system 100 is mounted to a vehicle 10, such as truck 10, such as for instance a tank truck comprising a tank 12. The present disclosure is not limited to a vehicle-mounted power supply system 100 configured to be mounted to a truck. The vehicle-mounted power supply system could be mounted to any other type of vehicles, such as, for instance, a bus, a car, a tractor, and the like.

In the embodiment shown, the vehicle-mounted power supply system 100 is mounted to a rear portion 14 of the vehicle 10, for instance rearwardly (considered with respect to a forward displacement A—FIG. 1 of the vehicle 10 when in use) with respect to one of the wheels 16 of the vehicle 10. Any other location of the power supply system 100 could be conceived.

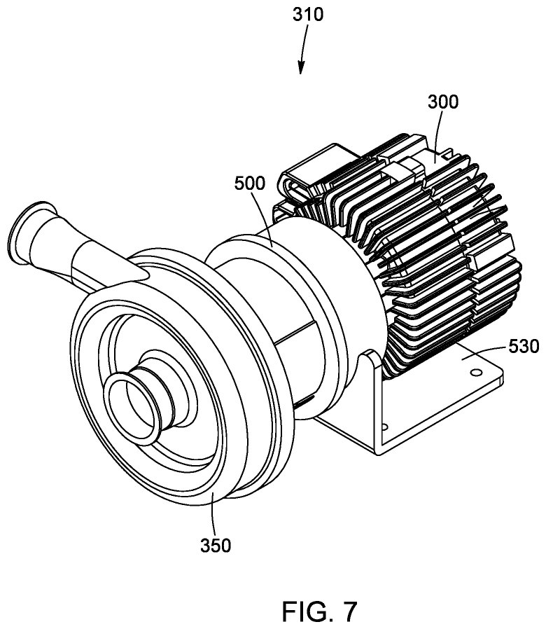

In the embodiment shown, and as detailed below, the electric motor 300 is mechanically coupled to a fluid transfer pump 350 to at least one of discharge a fluid from the tank 12 and fill the tank 12 with a fluid. When mechanically coupled together, the fluid transfer pump 350 and the electric motor 300 at least partially form together a fluid transfer pump assembly 310, such as shown in FIG. 7.

The vehicle-mounted power supply system 100 thus forms a truck-mounted fluid transfer pump system but other applications of the vehicle-mounted power supply system 100 could be conceived. For instance, the vehicle-mounted power supply system could be shaped and dimensioned so that the electric motor thereof would be mechanically coupled to a blower, or any other electrical equipment that could be provided on a vehicle (for instance a transport vehicle), such as, for instance and without being limitative, a crane, a lifting platform, a wrecker, a concrete mixer, and the like.

### Vehicle-Mounted Battery Assembly (or Truck-Mounted Battery Assembly)

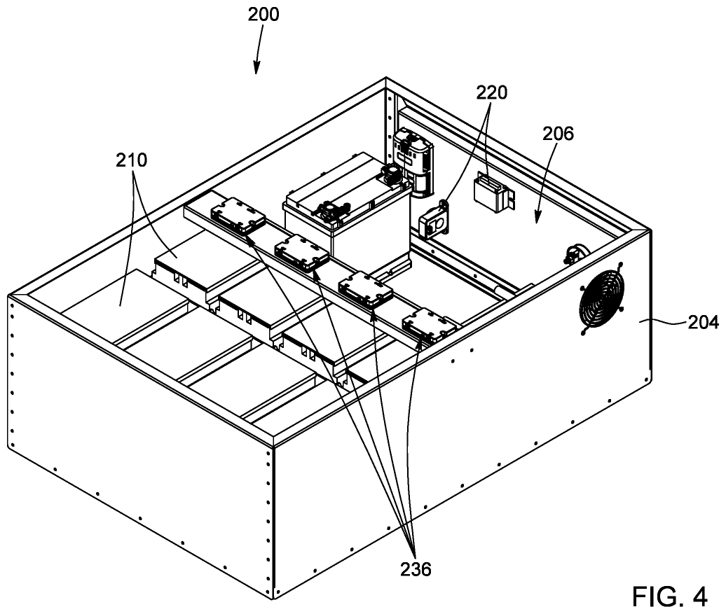

Referring now more particularly to FIGS. 4 to 6, the vehicle-mounted battery assembly 200 could be a lithium battery assembly (for instance of the lithium iron phosphate (LiFePO4) type or of the Lithium-Ion type). In the embodiment shown, the battery assembly 200 is configured to selectively provide a direct current to the electric motor 300.

In the embodiment shown, the vehicle-mounted battery assembly 200 is mounted to the tank 12 (for instance to a lower portion 13 thereof) so that the vehicle-mounted power supply system 100 can be used even when the tank (or the trailer) of the vehicle is separated from the vehicle tractor (not represented). In some embodiments, the vehicle-mounted battery assembly 200 is mounted to a trailer upon which the tank 12 sits.

In the embodiment shown, the battery assembly 200 comprises a plurality of battery blocks 210 electrically coupled to each other.

For instance, the battery assembly 200 is configured to provide a nominal voltage comprised between about 6 V and about 1000 V. For instance, the nominal voltage provided by the battery assembly is comprised between about 10 V and about 500 V. For instance, the nominal voltage provided by the battery assembly is comprised between about 20 V and about 200 V. For instance, the nominal voltage provided by the battery assembly is of about 50 V (for instance 48 V). In another embodiment, the nominal voltage provided by the battery assembly is of about 120 V. For instance, the battery assembly 200 has a capacity comprised between about 200 Ah and about 2000 Ah. For instance, the battery assembly 200 has a capacity comprised between about 300 Ah and about 500 Ah. For instance, the capacity of the battery assembly is of about 400 Ah.

In the embodiment shown, the battery assembly 200 further comprises a battery management system 220. The battery management system 220 is configured to manage, for instance, a temperature of at least one of the battery blocks 210, a charge level of at least one of the battery blocks 210, and the like.

The battery management system 220 is operatively coupled to the controller 120 of the vehicle-mounted power supply system 100. For instance, the battery management system 200 and the controller 120 are configured so that, in case of a dysfunction of the battery assembly 200 detected by the battery management system 220 and/or a communication interruption between the battery management system 220 and the controller 120 120, the controller 120 stops the electric motor 300 (and thus stops the fluid transfer pump when mechanically coupled to the electric motor 300). The controller 120 might also be configured to electrically isolate the battery 200 (for instance each battery block 210 thereof) from the electric motor upon detection of the dysfunction of the battery assembly 200 and/or detection of the communication interruption between the battery management system 220 and the controller 120, to limit the risk of critical failure thereof. In some embodiments, the battery management system 220 can include a battery isolator 223 in the event of a critical failure condition or an emergency.

The vehicle-mounted battery assembly 200 further comprises, a temperature-regulating assembly 230.

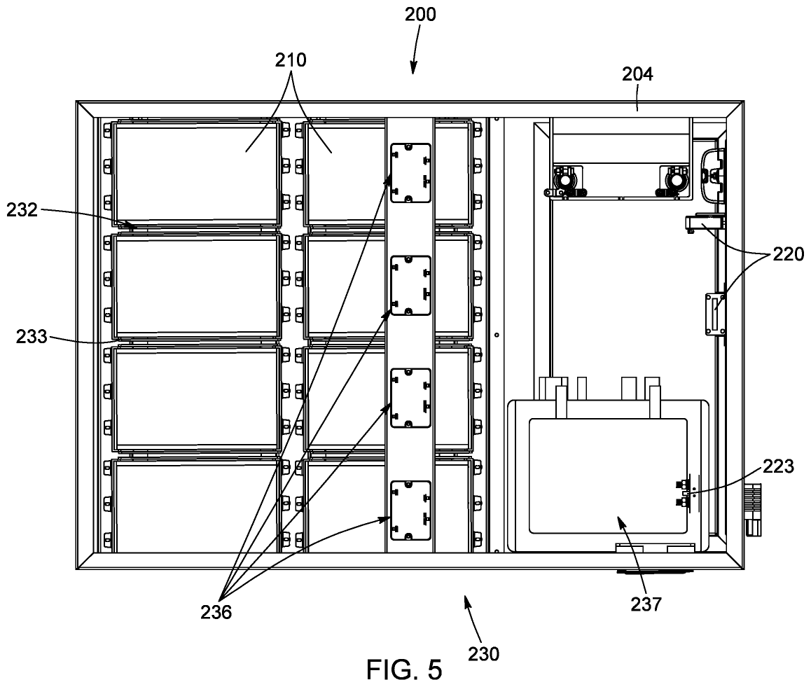

In the embodiment shown in FIG. 5, the temperature-regulating assembly 230 comprises a heating system 232 configured to maintain a temperature of at least one of the battery blocks 210 above a predetermined minimal temperature, so as not to deteriorate the battery blocks, for instance during winter. In some embodiments, the heating system 232 can comprise direct contact heating for at least one of the battery blocks 210.

The temperature-regulating assembly 230 further comprises a convection system 234 configured to transfer to an exterior of the battery assembly 200 a heat generated by the battery blocks during loading and/or unloading thereof and/or when the temperature of at least one of the battery blocks 210 is above a predetermined limit temperature. For instance, the convection system 234 might comprise an active cooling system, such as a circuit of a refrigerant fluid (for instance a liquid) that flows through the areas generating heat, such as the battery blocks 210, to an exterior of the battery. In other embodiments, the convection system can comprise a passive cooling system, such as heat dissipation fins. Other suitable cooling methods for controlling the temperature of the battery assembly 200 are also contemplated. In some embodiments, the convection system 234 can provide a convection air heater by using a charger and a voltage input of 120/240 volts.

The temperature-regulating assembly 230 might comprise a temperature management system operatively coupled to the convection system 234 and/or the heating system 232 to maintain the battery blocks 210 to an adequate temperature allowing their loading and unloading while limiting a risk of damaging them due to inappropriate temperatures. In some embodiments, the temperature management system is coupled via a thermocouple between at least one of the battery blocks 210 and the battery management system 220 such that the battery management system 220 controls the temperature management system. In some embodiments, the temperature management system can be part of one or more cell balancing modules 236. A cell balancing module 236 can be operatively coupled to and manage or control a plurality of battery blocks 210. Temperature sensors dispersed throughout the battery blocks 210 can provide temperature information to the cell balancing modules 236, such that the temperature management system can activate the heating system 232 or the convection system to moderate the temperature of the battery blocks 210. In some embodiments, the cell balancing module 236 can manage up to 16 battery blocks 210 and up to 10 temperature sensors or reading points. In other embodiments, the cell balancing module 236 can be coupled to more battery blocks 210 of temperature sensors or reading points.

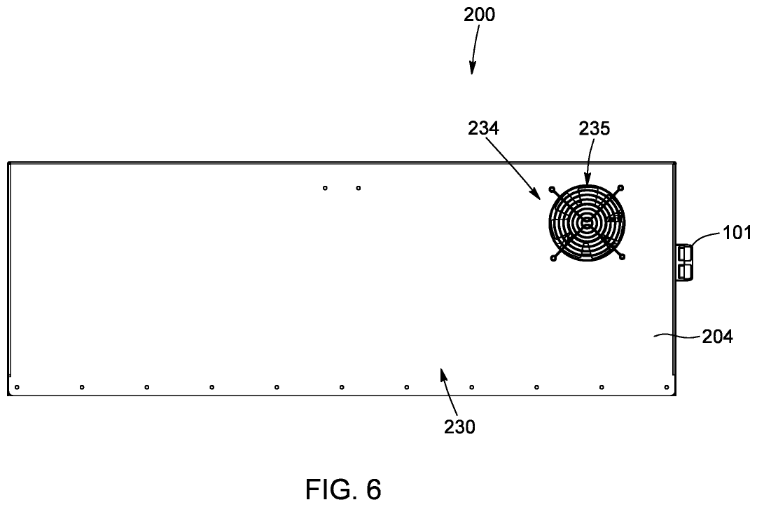

For instance, as best shown in FIG. 6, the convection system 234 comprises one or more fans 235 (for instance mounted in fan-receiving apertures 202 formed in a battery-containing casing 204) in order to allow a fluid circulation between a battery-containing cavity 206 at least partially delimited by the battery-containing casing 204 and an exterior thereof. For instance, the heating system 232 comprises a heating membrane 233 covering at least partially an inner surface of the battery-containing casing 206 and surrounding at least partially one or more battery blocks 210. In some embodiments, the battery-containing casing 204 can be isolated with insulation to improve temperature management, such as with 1 inch fire-proof foam.

It is appreciated that the shape, the configuration, and the location of the vehicle-mounted battery assembly 200, and the shape, the configuration, the location and/or the number of the battery blocks, the temperature-regulating assembly and the battery management system thereof can vary from the embodiment shown.

It is also understood that the features of the vehicle-mounted battery assembly will depend on the electric equipment configured to be driven by the vehicle-mounted power supply system.

### Battery Charger

As best shown in FIG. 5, the vehicle-mounted power supply system 100 further comprises a battery charger 237 electrically coupled to the battery assembly 200 and electrically couplable to a power source.

The battery charger 237 is configured to provide an output voltage corresponding to the voltage of the battery assembly 200. In some embodiments, the battery charger 237 can be used in battery charging mode or a heating mode, which can be determined by the controller 120. For example, in some embodiments, when in the heating mode, the controller 120 can prevent the battery charger 237 from charging the battery assembly when either the external temperature or a temperature of the battery blocks 210 is below 5° C. In other embodiments, the temperature management system can prevent the battery charger 237 from charging the battery assembly based on temperature data received from one or more temperature sensors.

As detailed below, the battery charger can be actuated via a communication system of the vehicle-mounted power supply system 100.

It is appreciated that the shape, the configuration, and the location of the battery charger can vary from the embodiment shown.

### Power Source

In the embodiment shown, the vehicle-mounted power supply system 100 comprises or is electrically couplable to a power source to at least one of charge the vehicle-mounted battery assembly 200 and power the electric motor 300. It is thus understood that the power source is electrically couplable to the vehicle-mounted battery assembly 200 and/or the electric motor 300.

In other words, the power source can be used to directly provide a voltage to the electric motor 300, either alone or in combination with a voltage outputted by the vehicle-mounted battery assembly 200, and/or to load at least one of the battery blocks 210 of the vehicle-mounted battery assembly 200.

In the embodiment wherein the power supply system 100 is electrically couplable to an external power source, the external power source can be couplable to the power supply system via an electrical outlet 101, for instance of the standard SAE J1772 or any other type, such as electrical outlets configured to load an electric vehicle.

In another embodiment, the vehicle-mounted power supply system 100 could be electrically couplable to another type of external power source, such as solar panels or an electric battery of the tractor vehicle.

### Electric Motor

In the embodiment shown, the electric motor 300 is of the direct current type.

For instance, the electric motor 300 has a rotational speed comprised between about 1000 RPM and about 6000 RPM. In another embodiment, the rotational speed is comprised between about 2500 RPM and about 4500 RPM. In another embodiment, the rotational speed of the electric motor 300 is about 3600 RPM.

The electric motor 300 could also be configured in a loading configuration wherein the electric motor 300 contributes to charging the battery assembly.

It is understood that the features and dimensions of the electric motor 300 will depend on the electric equipment the motor is configured to drive.

### Controller

The above-mentioned controller 120 of the vehicle-mounted power supply system 100 is operatively coupled to the vehicle-mounted battery assembly 200 (for instance to the battery management system and/or the temperature-regulating assembly thereof), the power source and the electric motor 300.

The controller 120 is configured to take in consideration one or more of the following parameters in order to adjust an actuation of one or more of the components of the vehicle-mounted power supply system 100: a temperature of at least one of the battery blocks and/or a temperature of the battery assembly, a charge level of at least one of the battery blocks and/or a charge level of the battery assembly, a rotational speed of the electric motor, an external temperature and the like. For instance, the controller 120 is configured to stop the electric motor 300 or at least reduce a power thereof when the temperature of the battery assembly is above a predetermined battery limit temperature.

As mentioned above, the controller 120 is configured to allow a direct power supply of the electric motor by the power source and/or to modify working parameters of the battery charger and/or the electric motor based on other parameters. The controller 120 can be configured to connect the electric motor 300 either to the vehicle-mounted battery assembly or to the power source.

The controller 120 might also be operatively coupled to an AC/DC converter or a DC/DC converter, for instance when the power source is an external power source.

It is understood that the features of the controller 120 will depend on the features and working parameters of the vehicle-mounted battery assembly and the electric motor.

For instance, the controller 120 is configured to adapt a charging protocol of the vehicle-mounted battery assembly 200 based on the power source of the vehicle-mounted power supply system or to which the vehicle-mounted power supply system is electrically coupled. For instance, the vehicle-mounted battery assembly 200 can be configurable into charging configurations depending on a plurality of parameters (for instance a first slow charging configuration when the battery assembly is electrically coupled to a P1 plug (120V, 15A) and a second quicker charging configuration when the battery assembly is electrically coupled to a J1772 plug or P2 plug).

The controller 120 can be configured to cooperate with the electric motor 300 and/or the piece of equipment the electric motor 300 is mechanically coupled to, to adjust at least one of the working parameters thereof, for instance depending on measured parameters. When the piece of equipment is a fluid transfer pump, a volume of the tank 12, a discharge flow of the fluid transfer pump, and/or a type of fluid contained in the tank 12 and the like can be used as measured parameters for optimising the working parameters of the piece of equipment, such as the pumping speed of the fluid transfer pump.

In some embodiments, the controller 120 can be configured to cooperate with sensors and the electric motor 300 and/or the fluid transfer pump assembly to monitor a change in temperature of the electric motor 300 or to monitor pressure in the tank 12 or of the fluid being expelled from the tank 12. If the temperature and/or pressure are outside predetermined parameters and/or a rapid increase or decrease in the temperature and/or pressure is determined, the controller 120 can be configured to stop the electric motor 300 (and thus stop the fluid transfer pump when mechanically coupled to the electric motor 300). In some embodiments, the controller 120 can be configured to trigger an automated stop or an emergency stop of the electric motor 300 and/or the fluid transfer pump assembly.

The controller 120 might also be configured to record different parameters of the vehicle-mounted power supply system 100. In some embodiments, the controller 120 can use an artificial neural network, artificial intelligence (AI), deep learning, or machine learning techniques to estimate and/or predict the optimal working parameters of the system depending on previous and current measured parameters. In some embodiments, these artificial neural network, AI, deep learning, and/or machine learning techniques can be implemented by the controller 120 or by a separate AI controller 121, such as a Raspberry Pi™. For example, the controller 120 or AI controller 121 can be configured to control the speed of the electric motor 300 based on previous and/or current temperatures of the electric motor 300 and/or control the pumping speed of the fluid transfer pump based on previous and/or current discharge flow of the fluid transfer pump, volume of the tank 12, and/or the type of fluid contained in the tank 12.

It is appreciated that the configuration of the controller 120 can vary from the embodiment shown.

### Communication System

In the embodiment shown, the vehicle-mounted power supply system 100 further comprises a communication system. For instance, the communication system can be of the CAN bus type but a communication system comprising any other suitable communication protocol could be conceived.

The communication system is for instance configured for the controller 120 to communicate in real time with the vehicle-mounted battery assembly 200 and the battery charger and to configure the battery assembly in a suitable configuration (for instance either the first slow charging configuration or the second quicker charging configuration) based on battery-relative data.

For instance, the communication system can use one or more communication protocols, such as 3G, 4G, Wi-Fi, Bluetooth and the like. For instance, the communication system can be configured to allow a remote actuation of at least one of the components of the vehicle-mounted power supply system.

It is appreciated that the configuration of the communication system can vary from the embodiment shown.

The vehicle-mounted power supply system could further comprise a user interface to manually actuate one or more of the components of the power supply system and/or to control and/or adjust working parameters thereof. For instance, the user interface might comprise a charger switch to enable or stop the charging of the battery assembly by the battery charger.

### Fluid Discharge Pump and Mechanical Connector

As mentioned above, the electric motor 300 is mechanically couplable to an electric equipment or appliance, for instance to the fluid transfer pump 350.

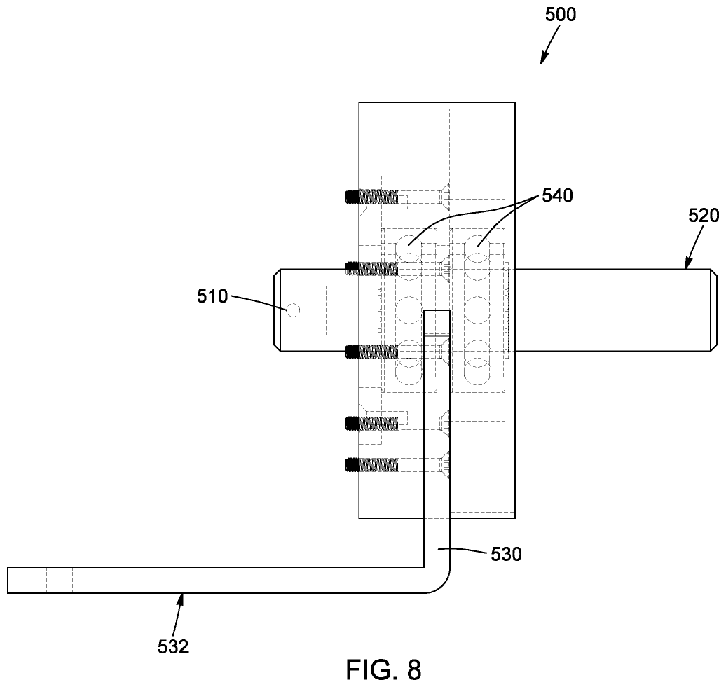

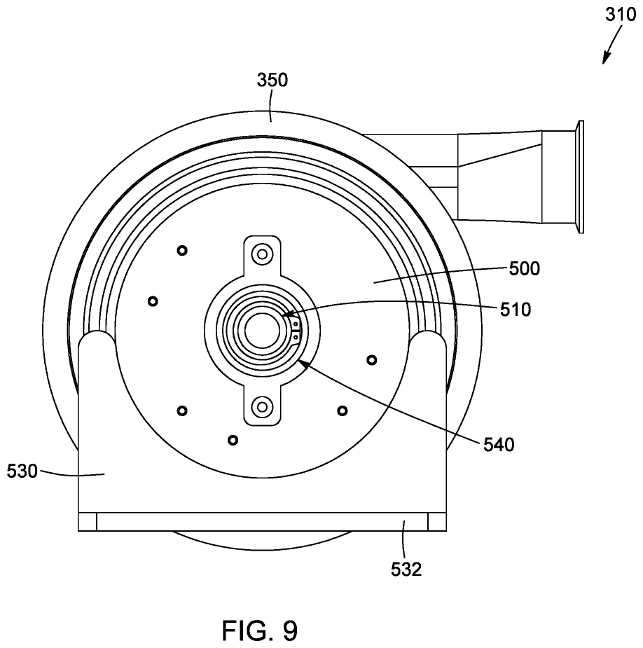

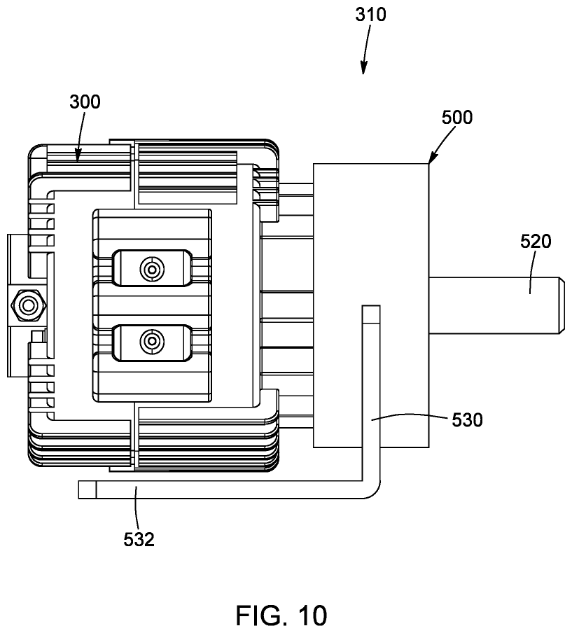

Referring now to FIGS. 7 to 10, for instance, the vehicle-mounted power supply system 100 comprises a mechanical connector 500 to mechanically couple together the electric motor 300 and the electric equipment (for instance the fluid transfer pump 350). The mechanic connector 500, together with the fluid transfer pump 350 and the electric motor 300, forms at least partially the above-mentioned fluid transfer pump assembly 310.

The fluid transfer pump assembly 310 can further comprise one or more sensors, for instance to measure a fluid transfer speed or a remaining fluid volume of the tank. The above-mentioned controller 120 could be operatively coupled to the sensors of the fluid transfer pump assembly 310, for instance to modify a rotational speed of the electric motor as a function of the measured parameters.

For instance, the mechanical connector 500 comprises a driven member 510 mechanically couplable to the electric motor 300, for instance to a shaft thereof.

The mechanical connector 500 further comprises a driving member 520 mechanically couplable to the electric equipment, for instance to the fluid transfer pump 350. For instance, the driving member 520 can be mechanically couplable to a pump head of the NEMA type.

The mechanical connector 500 further comprises one or more bearings 540 arranged between the driving member 520 and the driven member 510 in order to transmit all or part of the rotational speed of the electric motor 300 to the fluid transfer pump 350.

In the embodiment shown, the driving member 520 and the driven member 510 are both substantially cylindrical and substantially coaxial.

In the embodiment shown, the mechanical connector 500 is shaped and dimensioned to limit a clearance (for instance a radial clearance) between the electric motor 300 (for instance the shaft thereof) and the electric equipment (for instance the fluid transfer pump). Such a clearance could jeopardize the mechanical coupling between the electric motor and the fluid transfer pump.

In the embodiment shown, the mechanical connector 500 further comprises a supporting member 530 comprising a supporting base 532 extending, in the embodiment shown, at least partially under the electric motor 300 when mechanically coupled therewith.

It is appreciated that the shape, the configuration, and the location of the mechanical connector 500 can vary from the embodiment shown. The shape and configuration of the mechanical connector 500, for instance the shape and the configuration of the driving and driven members thereof, will depend on the electric motor and the electric equipment the mechanical connector is configured to mechanically couple.

It is thus understood that the vehicle-mounted power supply system is configured to provide a power source to actuate one or more electrically powered devices (such as for instance one or more fluid transfer pumps), for instance to perform usual tasks in the transport sector, such as discharging a fluid from a vehicle tank. The vehicle-mounted power supply in accordance with the above-described embodiments thus enables replacing hydraulically driven appliances and/or prevents from using a motor of the vehicle tractor to provide a power source to the electrically powered devices. Whereas the motor of the vehicle tractor usually needs to be running to enable the actuation of an electric equipment of the vehicle, thus resulting in noise and air pollutions, the vehicle-mounted power supply system as disclosed enables the motor of the vehicle tractor to be stopped or even the vehicle tractor to be uncoupled from the vehicle tank, for instance to be used to be coupled to another vehicle tank.

In other words, in the embodiment shown, the actuation of the electrically powered devices does not depend on a motorized unit distinct from the component of the vehicle to which the power supply system is mounted.

According to another aspect, there is provided a method for discharging a fluid from a tank of a truck. The method according to embodiments of the present disclosure may be carried out with a truck-mounted fluid transfer pump system such as those described above.

The method comprises providing a truck-mounted fluid transfer pump system comprising a truck-mounted battery assembly and a fluid transfer pump; electrically coupling the truck-mounted battery assembly and truck-mounted fluid transfer pump to provide a voltage outputted by the truck-mounted battery assembly to the fluid transfer pump; and discharging the fluid from the tank upon actuation of the fluid transfer pump.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited by the scope of the appended claims.

1. A vehicle-mounted power supply system, comprising:
a vehicle-mounted battery assembly;
an electric motor electrically coupled to the vehicle-mounted battery assembly; and
a controller operatively coupled to the vehicle-mounted battery assembly and the electric motor to selectively provide a voltage outputted by the vehicle-mounted battery assembly to the electric motor.

2. The vehicle-mounted power supply system of claim 1, comprising or being electrically couplable to a power source to at least one of charge the vehicle-mounted battery assembly and power the electric motor.

3. The vehicle-mounted power supply system of claim 2, wherein the power source is at least one solar panel or an electric battery of a vehicle the vehicle-mounted power supply system is operatively coupled to.

4. The vehicle-mounted power supply system of claim 1, wherein the electric motor is mechanically couplable to at least one of a fluid transfer pump, a blower, a crane, a lifting platform, a wrecker, and a concrete mixer.

5. The vehicle-mounted power supply system of claim 1, wherein the power supply system is mounted to a truck or a trailer comprising a tank and the electric motor is mechanically couplable to a fluid transfer pump to at least one of discharge a fluid from the tank of the truck and fill the tank with a fluid.

6. The vehicle-mounted power supply system of claim 1, further comprising a battery management system operatively coupled to the controller, wherein the battery management system is configured to manage at least one measured parameter of the vehicle-mounted battery assembly, wherein the controller is configured to stop actuation of the electric motor when the at least one measured parameter of the vehicle-mounted battery assembly is outside a predetermined range and/or a communication interruption between the battery management system and the controller is detected.

7. The vehicle-mounted power supply system of claim 6, wherein the at least one measured parameter of the vehicle-mounted battery assembly is a temperature of at least one of a plurality of battery blocks in the vehicle-mounted battery assembly, a charge level of the at least one of the plurality of battery blocks, a temperature of the vehicle-mounted battery assembly, and/or a charge level of the vehicle-mounted battery assembly.

8. The vehicle-mounted power supply system of claim 1, further comprising a temperature-regulating assembly operatively coupled to the vehicle-mounted battery assembly, wherein the temperature-regulating assembly comprises at least one of a heating system and a convection system.

9. The vehicle-mounted power supply system of claim 8, wherein the heating system is configured to maintain a temperature of the vehicle-mounted battery assembly and/or a temperature of at least one of a plurality of battery blocks of the vehicle-mounted battery assembly above a predetermined minimal temperature, wherein the heating system comprises a heating membrane at least partially covering an inner surface of a battery-containing casing and/or at least partially surrounding the at least one of the plurality of battery blocks.

10. The vehicle-mounted power supply system of claim 8, wherein the convection system is configured to transfer heat generated by at least one of the plurality of battery blocks to an exterior of the vehicle-mounted battery assembly during loading and/or unloading thereof and/or when a temperature of the at least one of the plurality of battery blocks is above a predetermined limit temperature.

11. The vehicle-mounted power supply system of claim 1, wherein the controller is configured to adjust an actuation and/or a working parameter of at least one of the vehicle-mounted battery assembly, the electric motor and a piece of equipment operatively coupled to the electric motor relative to at least one measured parameter.

12. The vehicle-mounted power supply system of claim 11, wherein the working parameter is at least one of a rotational speed of the electric motor, a voltage output of the vehicle-mounted battery assembly, an operation of a heating system, an operation of a convection system, and/or an operation of the piece of equipment.

13. The vehicle-mounted power supply system of claim 11, wherein the at least one measured parameter is a temperature of at least one of a plurality of battery blocks, a temperature of the vehicle-mounted battery assembly, a charge level of the at least one of the plurality of battery blocks, a charge level of the vehicle-mounted battery assembly, and/or an external temperature.

14. A truck-mounted fluid transfer pump system, comprising:
a truck-mounted battery assembly;
a fluid transfer pump assembly electrically coupled to the truck-mounted battery assembly; and
a controller operatively coupled to the truck-mounted battery assembly and the fluid transfer pump assembly to selectively provide a voltage outputted by the truck-mounted battery assembly to the fluid transfer pump assembly.

15. The truck-mounted fluid transfer pump system of claim 14, wherein the controller is configured to adjust an actuation or a working parameter of the truck-mounted battery assembly and/or the fluid transfer pump assembly relative to at least one measured parameter.

16. The truck-mounted fluid transfer pump system of claim 15, wherein the at least one measured parameter is a volume of a fluid being pumped, a discharge flow of the fluid transfer pump assembly, a type of the fluid being pumped, a temperature of the fluid transfer pump assembly, a pressure of the fluid being pumped, and/or a fluid transfer speed.

17. The truck-mounted fluid transfer pump system of claim 15, wherein the controller is configured to stop actuation of the fluid transfer pump assembly when the at least one measured parameter is outside of a predetermined range.

18. The truck-mounted fluid transfer pump system of claim 14, wherein the fluid transfer pump assembly comprises a fluid transfer pump and an electric motor configured to actuate the fluid transfer pump, wherein the fluid transfer pump assembly comprises a mechanical connector having a driven member and a driving member in a substantially coaxial relationship and separated by at least one bearing, wherein the driven member is mechanically coupled to the electric motor and the driving member is mechanically coupled to the fluid transfer pump.

19. A method for discharging a fluid from a tank of a truck, comprising:
providing a truck-mounted fluid transfer pump system comprising a truck-mounted battery assembly electronically coupled to a fluid transfer pump;
actuating the truck-mounted fluid transfer pump system to provide a voltage outputted by the truck-mounted battery assembly to the fluid transfer pump; and
discharging the fluid from the tank.

20. The method of claim 19, wherein the truck-mounted fluid transfer pump system further comprises a controller operatively coupled to the truck-mounted battery assembly and the fluid transfer pump, wherein actuating the truck-mounted fluid transfer pump system comprises actuating the controller, the method further comprising determining at least one measured parameter of the truck-mounted battery assembly and/or the fluid transfer pump and adjusting an actuation or a working parameter of the truck-mounted battery assembly and/or the fluid transfer pump relative to the at least one measured parameter.
